(19) United States
(12) Patent Application Publication
(10) Pub. No.: US 2017/0043245 A1
(43) Pub. Date: Feb. 16, 2017

(54) SIMULATION AIR PUMP AND GAME SYSTEM

(71) Applicant: SAINT-FUN INTERNATIONAL LTD., New Taipei City (TW)

(72) Inventor: Shih-Wei Ho, New Taipei City (TW)

(21) Appl. No.: 14/825,190

(22) Filed: Aug. 13, 2015

(51) Int. Cl. A63F 13/218; A63F 13/537

(52) U.S. Cl. CPC A63F 13/218; A63F 13/537

(57) ABSTRACT

A simulation air pump game system includes a simulation air pump including a bracket, an operating handle, a movable plate movable up and down by the operating handle in the bracket and a sensor for detecting a reciprocating motion of the movable plate and generating a detection signal each time the operating handle is operated to move the movable plate up and down through one cycle, a display, and a game console adapted for converting each detection signal provided by the simulation air pump into a control instruction and controlling the display to display predetermined air pumping simulation actions subject to the control instruction the scores thus obtained.

### BACKGROUND OF THE INVENTION

(a) Field of the Invention

The present invention relates to video game technology, and more particularly to a simulation air pump game system, which enables each player to simulate the pumping of an air pump in inflating and exploding each selected target on a display screen subject to the sensing of a sensor and signal conversion processing of a control circuit assembly in a game console, so that a respective score can be obtained when each captured target is exploded.

(b) Description of the Prior Art

Conventional indoor amusement machines generally provide a hardware equipment for allowing a player to ride or to manipulate so as to produce specific amusement effects, such as coffee cup amusement park equipment, carousal, mini roller coaster, bumper cars, basketball shooting machine, fish scooping game machine and etc. There are also known a variety of video game systems such as racing game machines, shooting game machines, fighting game machines, rock-paper-scissors machines, etc. that combine a game console, a display screen and a computer software program into a system that allows the player to operate an operating device in controlling change of the content of the picture that is displayed on the display screen. Thus, the players can adventure sound and lighting effects.

Few computer software incorporated indoor amusement machines are commercially available. Regular hardware-based amusement machines are all in pursuit of speed or sensation-based pleasure. A basketball shooting game can provide the effects of muscle training and game playing, however, it doesn't provide any sound and lighting effects. Further, regular display screen-incorporated game machines simply emphasize on the entertainment effects of changes in sound and light that are produced by the display screen. In general, conventional amusement and game machines are imperfect.

### SUMMARY OF THE INVENTION

The present invention has been accomplished under the circumstances in view. It is therefore the main object of the present invention to provide a simulation air pump and game system, which combines a hardware equipment and a computer software into a system so that each player can simulate the pumping of an air pump to inflate and explode each selected target on a display screen subject to the sensing of a sensor and signal conversion processing of a control circuit assembly in a game console, and a respective score can be obtained when each captured target is exploded, and thus, every game player playing the simulation air pump game system can exercise body muscles and adventure sound and lighting effects.

### BRIEF DESCRIPTION OF THE DRAWINGS

FIG. 1 is an oblique top elevational view of a simulation air pump game system in accordance with the present invention.

FIG. 2 is a front view of the simulation air pump game system shown in FIG. 1.

FIG. 3 is a schematic side view of a simulation air pump for simulation air pump game system in accordance with the present invention.

FIG. 4 is an exploded view of the simulation air pump shown in FIG. 3.

FIG. 5 is an oblique top elevational view of the simulation air pump shown in FIG. 3.

FIG. 6 is a front view of FIG. 5.

FIG. 7 is a schematic side view illustrating a pumping operation of the simulation air pump in accordance with the present invention (I).

FIG. 8 is a schematic side view illustrating a pumping operation of the simulation air pump in accordance with the present invention (II).

FIG. 9 is a schematic drawing illustrating a game content displayed on the display of the air pump simulation game system.

FIG. 10 corresponds to FIG. 9, illustrating a target pumping operating 2 status.

### DETAILED DESCRIPTION OF THE PREFERRED EMBODIMENTS

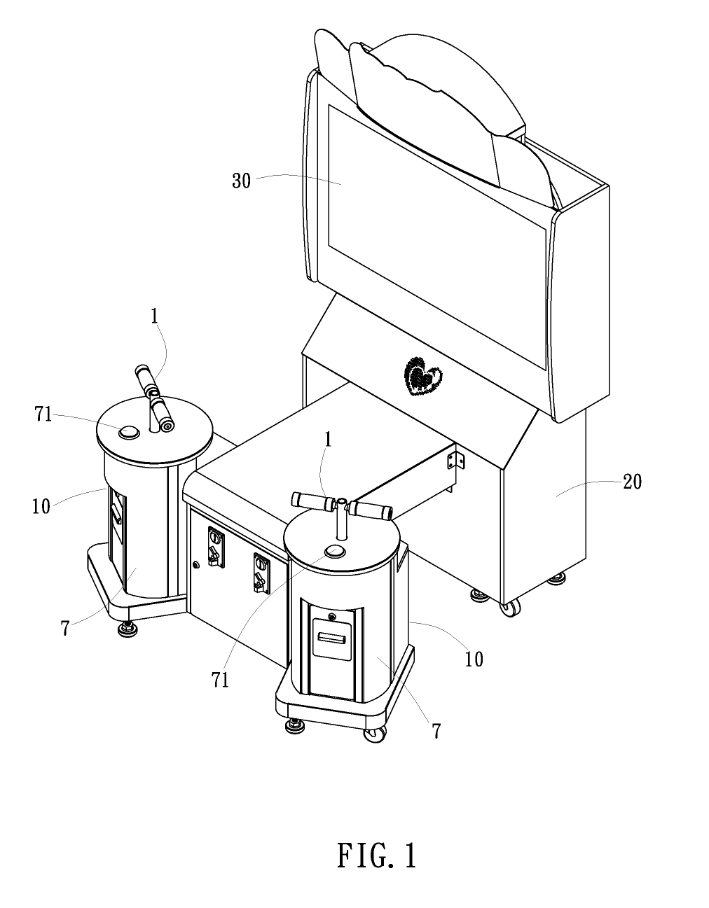

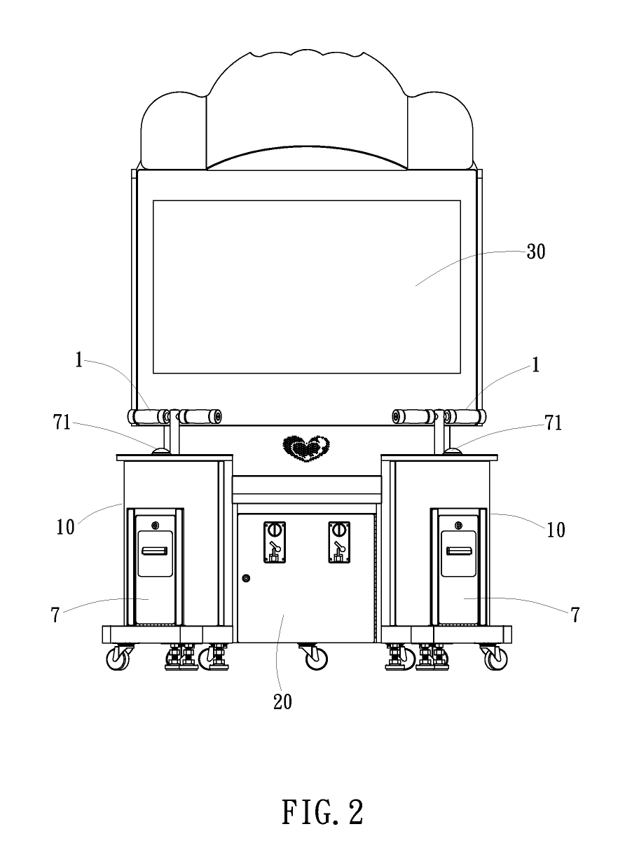

Referring to FIGS. 1 and 2, an air pump simulation game system in accordance with the present is shown. The air pump simulation game system comprises at least one simulation air pump 10, a game console 20 and a display 30 (screen).

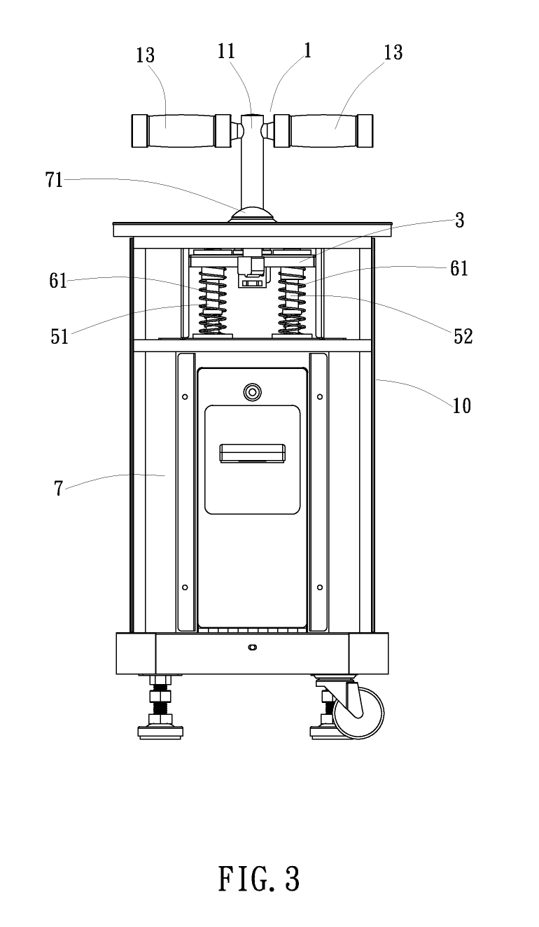

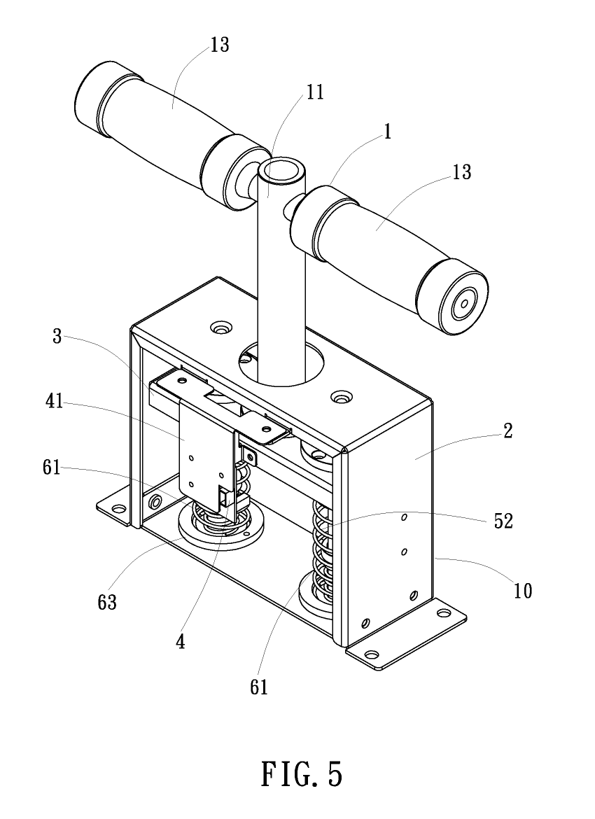

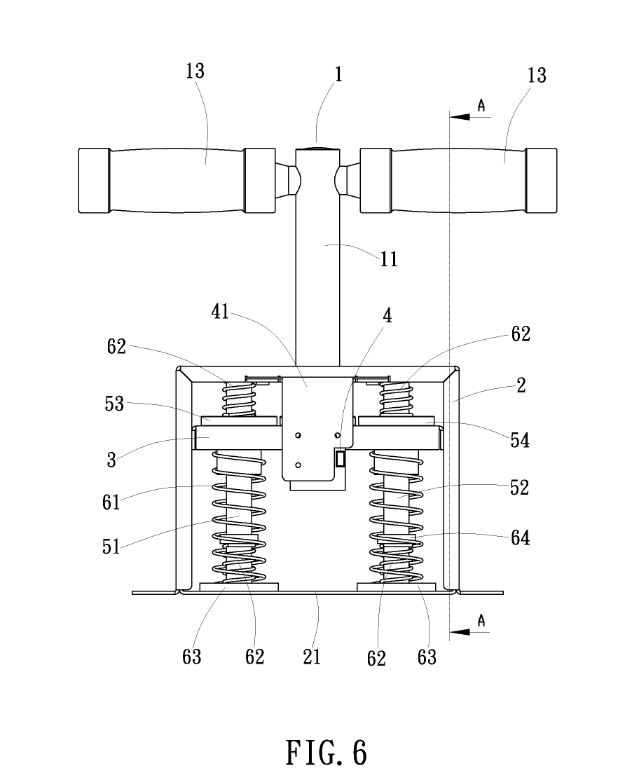

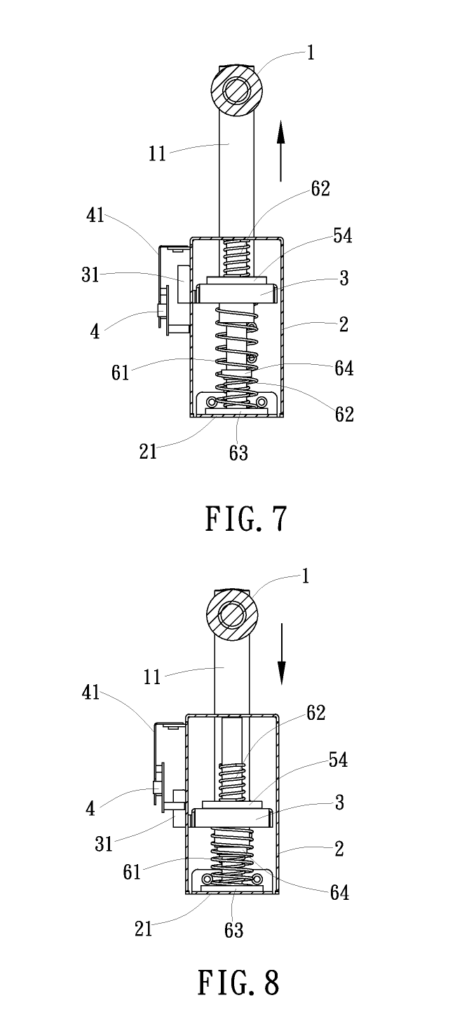

The simulation air pump 10, as shown in FIGS. 3-6, comprises a bracket 2, a movable plate 3 movably disposed in the bracket 2, an operating handle 1 vertically inserted through the bracket 2 and fixedly connected with the movable plate 3 and operable to move the movable plate 3 up and down in the bracket 2, a sensor 4 fixedly mounted in the bracket 2, two guide rods 51,52 inserted through the movable plate 3 and fixedly mounted in the bracket 2 in a parallel manner, two compression springs 61 respectively mounted on the guide rods 51,52 to support the movable plate 3 in the bracket 2, and an induction shutter 31 affixed to the movable plate 3 and movable with the movable plate 3 relative to the bracket 2 and the sensor 4. During reciprocating operation of the operating handle 1, the induction shutter 31 is moved with the movable plate 3 up and down to pass through the detection range of the sensor 4 (see FIG. 7 and FIG. 8). Each time the induction shutter 31 passes through the detection range of the sensor 4, the sensor 4 achieves the detection of one air pumping simulation action and generates a corresponding detection signal.

The game console 20 is electrically coupled with the at least one simulation air pump 10 and the display 30, having built therein a control circuit assembly consisting of a circuit substrate, electronic control components and an operating software. The control circuit assembly of the game console 20 is adapted for receiving each detection signal from the sensor 4 of each simulation air pump 10, converting each detection signal into a control instruction, driving the display 30 to display video game content and the action of air pump simulation at each target in the video game content and count the score that is obtained upon explosion of each displayed target.

The display 30 is adapted for displaying all kind of graphics according to the selected game content, including targets for capturing. The control instructions produced during the air pump simulation operation of the at least one simulation air pump 10 with the game console 20 are converted into corresponding imaging actions. When the operating handle 1 is being continuously moved up and down, the captured target (graphic) is being continuously expanded and a score is obtained when the captured target explodes.

In the simulation air pump game system consisting of the at least one simulation air pump 10, the game console 20 and the display 30, each simulation air pump 10 is coupled to the game console 20 that has a computer game software built therein. When a game player pumps one simulation air pump 10, the pumping actions are detected and converted into corresponding control instructions, when captured targets explode, scores are accumulated. Thus, every game player playing this simulation air pump game system can exercise body muscles and adventure sound and lighting effects.

Further, the operating handle 1 of the simulation air pump 10 is shaped like a T-bar, comprising a shaft 11 vertically inserted through the bracket 2 and fixedly connected to the movable plate 3, two grip rods 12 transversely and fixedly connected to a top end of the shaft 11 at two opposite sides above the bracket 2, and two grip sleeves 13 respectively mounted on the grip rods 12.

Further, the sensor 4 of the simulation air pump 10 is fixedly mounted at a mounting plate 41, and then the mounting plate 41 is affixed to the bracket 2 at a selected location, enabling the sensor 4 to mate with the induction shutter 31 at the movable plate 3. Thus, each time the movable plate 3 is moved up and down through one cycle, the sensor 4 is induced to produce a detection signal.

Further, the two guide rods 51,52 of each simulation air pump 10 are inserted through the associating movable plate 3 and fixedly connected between the associating bracket 2 and a bottom plate 21. The compression springs 61 of each simulation air pump 10 are respectively mounted on the guide rods 51,52 and stopped between the movable plate 3 and the bottom plate 21. Further, buffer springs 62 are respectively mounted on opposing top and bottom ends of the guide rod 51,52. Further, the guide rods 51,52 are respectively inserted through respective linear bearings 53,54 that are mounted in the movable plate 3.

The compression springs 61 are adapted for the simulation of air pressure reaction in an air pumping operation. When the operating handle 1 is pressed down, the compression springs 61 impart a resistance to simulate air pumping. When the downward pressure is released from the operating handle 1, the elastic potential energy of the compression springs 61 is released to return the operating handle 1 to its former position. The arrangement of the buffer springs 62 at the opposing top and bottom ends of the guide rods 51,52 provides protection against impact between the guide rods 51,52 and the associating bracket 2 and bottom plate 21, avoiding noises and prolonging the lifespan of the simulation air pump 10.

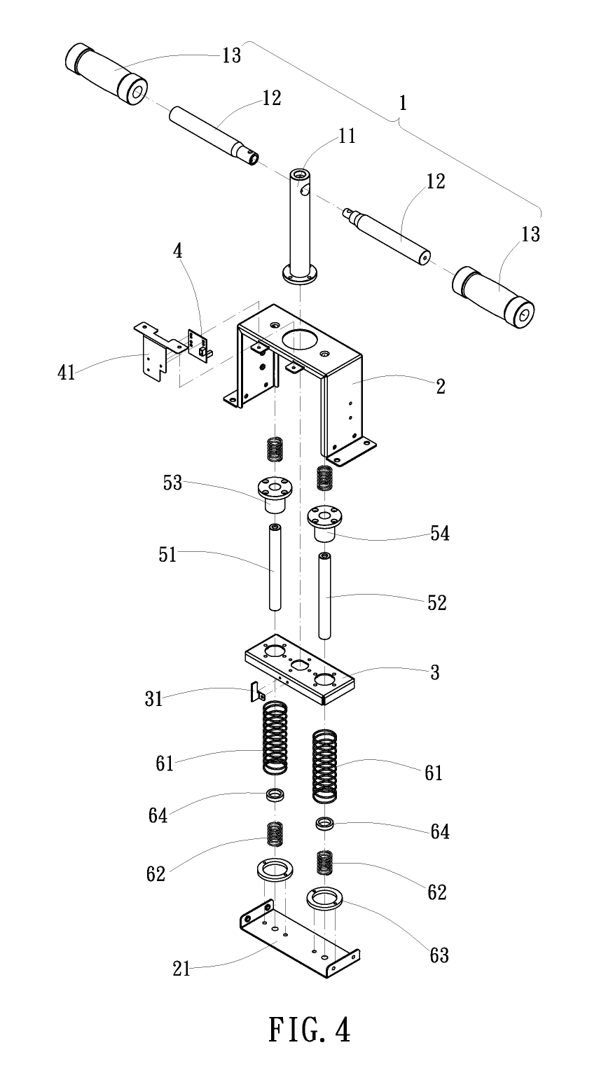

Further, as shown in FIG. 4, a spring positioning ring 63 is mounted at a bottom side of each compression spring 61 to hold the respective compression spring 61 at the bottom plate 21. Further, a rubber cushion 64 can be provided at a top side of each buffer spring 62 to enhance buffering and protection effects.

Further, as shown in FIG. 1, each simulation air pump 10 further comprises an outer housing 7 affixed to the game console 20.

Further, as shown in FIG. 1, a control button 71 is located at a selected location at a top side of the outer housing 7 of each simulation air pump 10. The control button 71 is configured to mate with the game software for capturing (locking) a target that is displayed on the display 30.

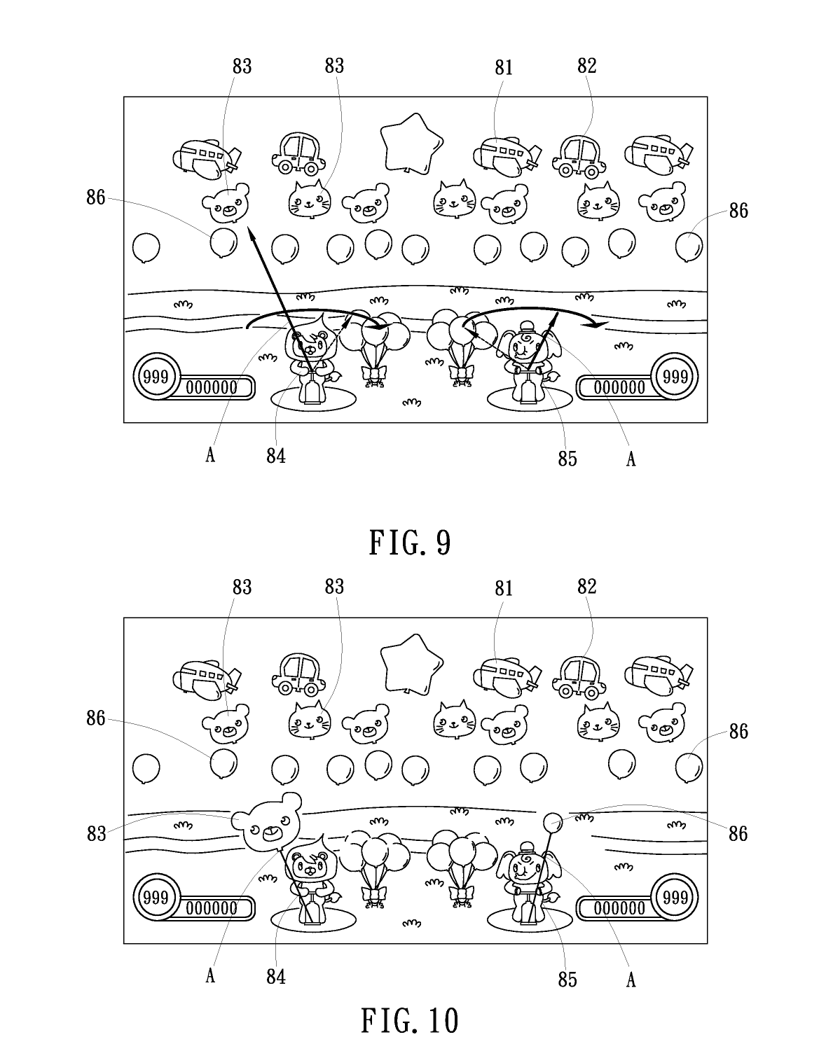

Further, as shown in FIG. 9, different targets 81,82,83 and doll 84,85 are displayed on the display 30, wherein the dolls 84,85 represent air pumping of different players; directional arrow signs A are adapted for aiming at different targets 81,82,83; graphics referenced by 86 are obstacles to hinder the directional arrow signs A from pointing out some of the targets 81,82,83. During the game, the directional arrow signs A must be extended over obstacles 86 to capture the desired target 81, 82 or 83 and then to pull back the captured target 81, 82 or 83 (see FIG. 10) so that the captured target 81, 82 or 83 can be inflated and exploded to achieve scoring.

What is claimed is:

1. A simulation air pump, comprising: an operating handle, a bracket, a sensor and at least one compression spring, wherein said operating handle is inserted through said bracket and coupled with said at least one compression spring; said sensor is configured to detect a reciprocating motion of said operating handle and to generate a detection signal each time said operating handle completes one reciprocating motion.

2. The simulation air pump as claimed in claim 1, further comprising a movable plate vertically movably disposed in said bracket and fixedly connected to a bottom end of said operating handle for reciprocating motion with said operating handle, two guide rods inserted through said movable plate and affixed to said bracket in a parallel manner to guide reciprocating movement of said movable plate in said bracket, two compression springs respectively mounted on said guide rods to support said movable plate in said bracket, and an induction shutter fixedly mounted at said movable plate and movable with said movable plate through a detection range of said sensor.

3. The simulation air pump as claimed in claim 2, wherein said operating handle comprises a shaft vertically inserted through said bracket and fixedly connected with said movable plate, two grip rods transversely and fixedly connected to a top end of said shaft at two opposite sides above said bracket, and two grip sleeves respectively mounted on said grip rods.

4. The simulation air pump as claimed in claim 1, further comprising a mounting plate carrying said sensor and affixed to said bracket.

5. The simulation air pump as claimed in claim 2, further comprising a bottom plate affixed to said bracket at a bottom side to hold a respective bottom end of each said guide rod, a plurality of buffer springs respectively mounted on opposing top and bottom ends of each said guide rod, and a linear bearing affixed to said movable plate to support each said guide rod in said movable plate.

6. The simulation air pump as claimed in claim 1, further comprising a spring positioning ring mounted at a bottom side of each said compression spring.

7. The simulation air pump as claimed in claim 5, further comprising a rubber cushion mounted at a top side of each said buffer spring.

8. A simulation air pump game system, comprising at least one simulation air pump, a game console and a display, wherein: each said simulation air pump comprises a bracket, to guide rods fixedly mounted in said bracket, a movable plate axially movably coupled to said guide rods in said bracket, two compression springs respectively mounted on said guide rods to support said movable plate in said bracket, an operating handle inserted through said bracket and connected with said movable plate and operable to move said movable plate alternatively up and down relative to said bracket, an induction shutter mounted at said movable plate, and a sensor mounted in said bracket and configured to detect a reciprocating motion of said induction shutter with said movable plate and to generate a detection signal each time said operating handle is operated to move said movable plate up and down through one cycle.
said game console is coupled with each said simulation air pump and said display and adapted for converting each said detection signal from one respective said simulation air pump into a control instruction for controlling said display to display predetermined air pumping simulation actions;
said display is configured to display predetermined graphics and a plurality of targets and said predetermined air pumping simulation actions subject to control instructions provided by said game console.

9. The simulation air pump game system as claimed in claim 8, wherein each said simulation air pump further comprises an outer housing.

10. The simulation air pump game system as claimed in claim 8, wherein each said simulation air pump further comprises a control button mounted at said outer housing at a selected location.
